(19) United States
(12) Patent Application Publication
(10) Pub. No.: US 2024/0217801 A1
(43) Pub. Date: Jul. 4, 2024

(54) MICRO FACTORY SYSTEM FOR ON-DEMAND DISPENSING OF BEVERAGES

(71) Applicant: GROUPE ETHICAL FACTORY INC., Saint-Lambert (CA)

(72) Inventors: Daniel COUILLARD, Morin-Heights (CA); Olivier PÉTRIGNET, Saint-Sauveur (CA)

(21) Appl. No.: 18/289,043

(22) PCT Filed: May 30, 2022
(86) PCT No.: PCT/IB2022/055066

§ 371 Date: Oct. 31, 2023

Related U.S. Application Data
(60) Provisional application No. 63/202,137, filed on May 28, 2021.

(30) Foreign Application Priority Data
May 28, 2021 (CA) 3120038

(51) Int. Cl. B67C 7/00; A23L 2/54; G07F 7/06; G07F 9/02; G07F 11/72; G07F 13/06; G07F 17/20

(52) U.S. Cl. CPC B67C 7/00; A23L 2/54; G07F 7/0609; G07F 9/023; G07F 11/72; G07F 13/065; G07F 17/20

(57) ABSTRACT

There is provided a micro factory system for on-demand dispensing of beverages made in response to consumer preferences, providing customized drink preparations at the point of sale, essentially eliminating the need for disposable containers, said system comprising a water supply, a carbon dioxide supply, a plurality of supply means for storing extracts, flavoring agents or additives, such as nutritional additives supplies, a reusable bottle supply, a bottle sanitizer, a bottle filling station, a forced air HEPA filtration system configured to maintain a positive pressure within the micro factory system, wherein the bottles are provided with a removable cap, said system further comprising a consumer interface for programming by consumers so as to cause said micro factory to generate a custom beverage and further comprising network interface for networking said system to a remote location.

### FIELD

The present technology relates to a micro factory system for on-demand dispensing of beverages.

### BACKGROUND

At points of sale to consumers, millions of ready to drink beverages such as water, soft drinks, juices and so on, are sold every day in plastic, glass, or metal containers. Most of these containers fail to be recycled or require large energy expenditures for transport to recycling facilities and eventual recycling. Furthermore, the additional energy expenditure of distributing full beverage containers across vast distances and often cooling these in refrigerated display cases at a point of sale, is enormous.

Concentrated flavoring agents are known for use in mixing with water to impart a taste profile to the water. Frozen concentrates, such as juices, are also sold and intended for dilution with water prior to drinking. Similarly, powder mixtures, such as hot chocolate mixes, are meant to be mixed with water or milk to provide drinks. However, such preparations require handling, dosing, and preparation steps before being ready to drink. Such products have not curtailed the enormous use of dispensable containers.

Various beverage dispensing systems have been developed to provide a customized drink by mixing diluent liquids and concentrates. Notable examples are the Freestyle™ machines distributed by the Coca-cola Company. See for example, U.S. Pat. Nos. 10,000,370, 8,744,618, 10,029,904, 9,014,846 and 10,384,925. The machine distributes sodas or mixtures thereof by combining a carbonated water and flavoring extracts. The choice of drink is made by the user on a touchpad user interface and the chosen drink is poured in a cup.

Another example, this time in the alcoholic beverage area is the Smartender™ distributed by the Smart Bar company, see for example U.S. Pat. No. 9,776,848, entitled Automatic Beverage Dispenser. In some embodiments, the self-contained system can hold dozens of alcohol product bottles and mixers in pouches along with water or carbonated water. A bartender can choose from a touchpad user interface screen a particular cocktail and the cocktail is made automatically and poured into a glass.

Various vending forms of vending machines are also well known. These typically hold and sell canned or bottle beverages and snacks. These and other machines do not allow for sanitary disinfection of containers or hands of the user and as such can be a vector for germ or virus propagation.

Finally, various automatic coffee machines also exist where coffee beans are ground or pre-ground, and coffee or coffee-based drinks are extracted and dispensed.

However, despite these known technologies, there remains a need for a system that will provide point of sale, customized drink preparations, that will essentially eliminate the need for disposable containers and that can provide a user experience featuring customer recognition, social media access and sanitary operating conditions.

### SUMMARY

It is an object of the present technology to ameliorate at least some of the inconveniences present in the prior art. One or more embodiments of the present technology may provide and/or broaden the scope of approaches to and/or methods of achieving the aims and objects of the present technology.

Developer(s) of the present technology have appreciated that there is an enormous ongoing waste of materials and energy in the sale of beverages sold in disposable containers.

Thus, one or more embodiments of the present technology are directed to a micro factory providing customized beverages to users. The micro factory is equipped with reusable bottle cleaning technology means, user interface technology for custom ordering of beverages, optional user recognition and greeting, sanitary functions, optional social media access, optional payment systems and optional display screen technology for displaying advertising or various content feeds. In some embodiments, the micro factory provides dispensing of reusable bottles. In some embodiments, the micro factory is in remote communication with a network linked to a processor and database for monitoring micro factory functions remotely, adapting micro factory functions such as display features and external colors of the micro factory structure and for remotely diagnosing the micro factory and ordering supplies or servicing as required.

### Definitions

In the context of the present specification, a “micro factory” is a self-contained and in some embodiments freestanding point of sale unit apparatus featuring a user interface for receiving beverage container automatic cleaning and/or automatic beverage making commands and having other technological features. The “micro factory” can, for example, be provided with water filtration and/or disinfection means and water carbonation means. The flavor concentrates can be liquids or powders, preferably powders that are held in operable containers for dispensing precise amounts in the preparation sequence of a flavored beverage. In embodiments, the “micro factory” is fluidly connected to a domestic water source available at the point of sale such as a convenience store and can include on-board water purification technology. In embodiments the “micro factory” is electrically connected to a power source.

The term “server” is meant to refer to computer program that is running on appropriate hardware and is capable of receiving requests (e.g., from electronic devices) over a network (e.g., a communication network), and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expressions “at least one server” and “a server”.

The term “electronic device” is any computing apparatus or computer hardware that is capable of running software appropriate to the relevant task at hand. Thus, some (non-limiting) examples of electronic devices include general purpose personal computers (desktops, laptops, netbooks, etc.), touchpad user interfaces, display screens, mobile computing devices, smartphones, and tablets, and network equipment such as routers, switches, and gateways. It should be noted that an electronic device in the present context is not precluded from acting as a server to other electronic devices. The use of the expression “an electronic device” does not preclude multiple electronic devices being used in receiving/sending, carrying out or causing to be carried out any task or request, or the consequences of any task or request, or steps of any method described herein. In the context of the present specification, a “client device” refers to any of a range of end-user client electronic devices, associated with a user, such as personal computers, tablets, smartphones, and the like.

The expression “computer readable storage medium” (also referred to as “storage medium” and “storage”) is intended to include non-transitory media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

The term “database” is any structured collection of data, irrespective of a particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

The term “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e.: its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

The expression “communication network” is intended to include a telecommunications network such as a computer network, the Internet, a telephone network, a Telex network, a TCP/IP data network (e.g., a WAN network, a LAN network, etc.), and the like. The term “communication network” includes a wired network or direct-wired connection, and wireless media such as acoustic, radio frequency (RF), infrared and other wireless media, as well as combinations of any of the above.

In the context of the present specification, the word “about” when used in relation to numerical designations or ranges means the exact numbers plus or minus experimental measurement errors and plus or minus 10 percent of the exact numbers.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a front cross-sectional view of the micro factory system in accordance with one or more non-limiting embodiments of the present technology.

FIG. 2 depicts a side cross-sectional view of the micro factory system of FIG. 1 in accordance with one or more non-limiting embodiments of the present technology.

FIG. 3 depicts a schematic diagram of the interior bottle handling portion of the micro factory system of FIGS. 1 and 2.

FIG. 4 depicts a schematic diagram of the top front elevation of the micro factory in accordance with the previous FIGS. 1-3.

FIG. 5 depicts a schematic diagram of the interior of the water reservoir bottom portion of the micro factory in accordance with the previous FIGS. 1-4.

FIG. 6 is a schematic front elevation view of an embodiment of the micro factory with cover doors opened to show in the interior components.

FIG. 7 is a schematic front elevation view of the micro factory of FIG. 6 with cover doors closed.

FIG. 8 is a schematic front elevation view of the micro factory of FIG. 6 with the bottle drop off zone cover in closing mode.

FIG. 9 is a schematic front elevation view of the micro factory of FIG. 6 with the bottle being injected with extracts, flavors or additives.

FIG. 10 is a schematic front elevation view of the micro factory of FIG. 6 with the bottle being filled with water.

FIG. 11 is a schematic diagram of the micro factory of FIG. 6 with the bottle being sanitized in the bottle drop off zone.

FIG. 13 is a schematic exploded perspective view of the bottle used in the micro factory.

FIG. 14 is a schematic perspective view of the micro factory FIG. 15 is another schematic perspective view of the micro factory.

FIG. 16 is another schematic front elevation of an embodiment of the micro factory with cover doors opened to show the interior components.

FIG. 17 is a schematic network diagram.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through dedicated hardware as well as hardware capable of executing software in association with appropriate software. When provided by a processor, the functions may be provided by a single dedicated processor, by a single shared processor, or by a plurality of individual processors, some of which may be shared. In one or more non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, applications or algorithms, may be represented herein as any combination of flowchart elements or other elements indicating performance of process steps and/or textual or visual description. Such modules may be executed by hardware that is expressly or implicitly shown.

With these fundamentals in place, we will now consider some non-limiting examples to illustrate various implementations of aspects of the present technology.

### Micro Factory Structure

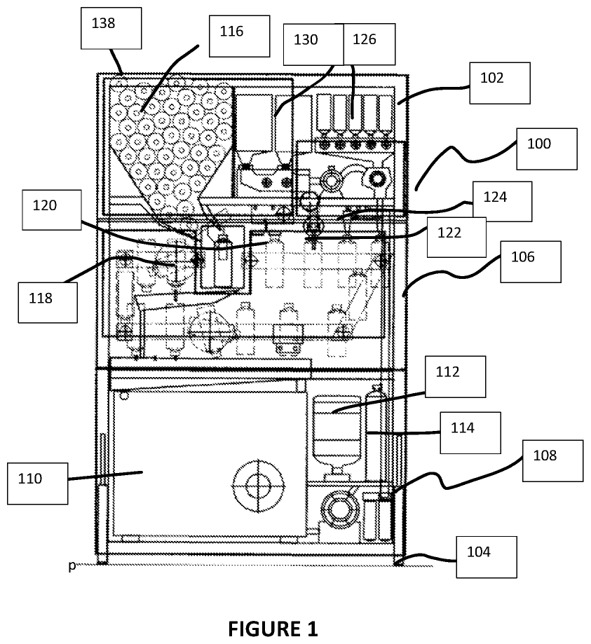

With reference to FIG. 1, there is depicted a front cross sectional interior view of a micro factory system 100 in accordance with one or more non-limiting embodiments of the present technology.

The micro factory 100 is used to automatically prepare customized beverages upon receiving user commands. The micro factory comprises and external frame 102 made of steel or other suitable material. Frame 102 rests on leveling feet 104 and houses a top section 106 and a lower section 108. The lower section 108 contains a water tank 110 that can be fluidly connected to an available water supply. Lower section 108 can also comprise an external water tank 112. It also comprises a carbon dioxide pressurized cylinder 114.

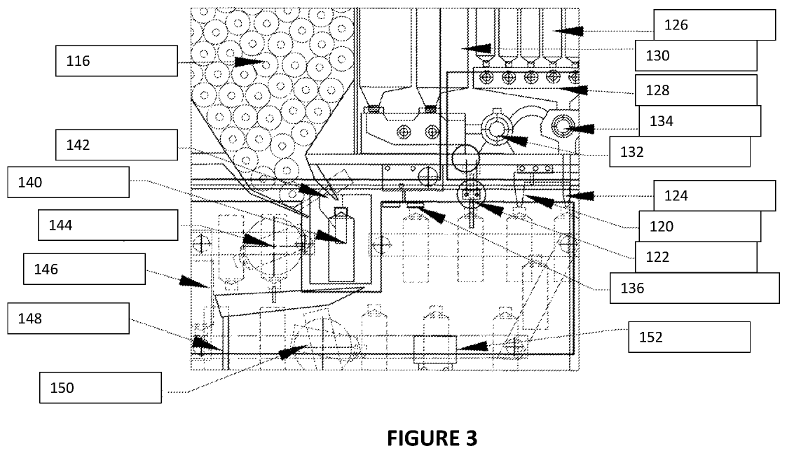

Meanwhile, the top section 106 comprises, as illustrated, a horizontally disposed stack of refillable beverage bottles 116 that are housed in a hopper for dispensing bottles 116 to a washing and sanitation station 118. Clean and sanitized bottles 116 are seized and mechanically made to travel along a path directing them to a filling station 120 for water. Carbon dioxide 122 can then be injected in the filled water bottles 116 if the consumer choice is carbonated water. Flavor extracts, additives, or nutritional supplements 124 housed in a plurality of cylinders 126 or 130 that can contain powders, pellets, or liquids are added as per the consumer beverage choice. Mixer 132 mixes flavor extracts, additives, or nutritional supplements 124 solutions, powders, tablets or pellets. Before injection into bottles 116, the extracts, additives or supplements 124 are properly dosed by dosage meter 128 (see FIG. 3). Injector 134 injects these into bottles 116 upon filling. After filling, the bottles 116 are provided with a sealing membrane 136 preferably applied with pressure adhesive for a hermetic seal. A screwed-on cap is then added (not shown). The filled bottle are then moved to a retrieval zone for grasping by the consumer.

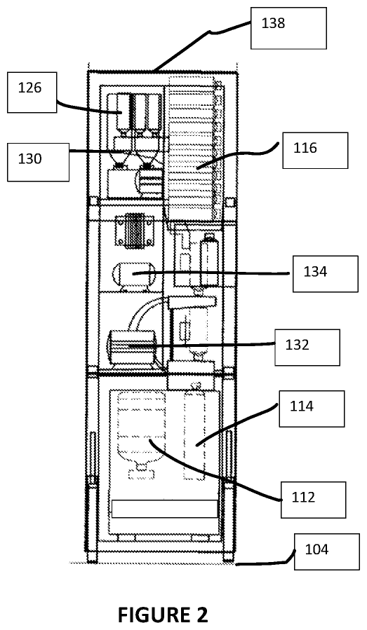

Referring now to FIG. 2, a side cross-section view is shown. A removable and lockable top hatch 138 provides access to reload the micro factory 100 with new reusable bottles 116 and cylinders 126 and 130. Similarly, other hatches provide access (not shown) to various other parts and consumables for the purpose of servicing and maintenance.

Turning now to FIG. 3, there is provided a more detailed cross-sectional interior view of the top section 106 of the micro factory 100. Additives, extracts and nutritional supplements 124 are pre-loaded in cylinders 126 and 130. The number of cylinders is a function of the model of micro factory and can vary without departing from the invention. In operation, consumers and users of micro factory 100 can either purchase a new reusable bottle 116 from the micro factory 100 or bring their reusable bottle for insertion into bottle drop area 140. It is noted that in a preferred embodiment, only genuine bottles sized and shaped exactly for use with micro factory 100 are accepted by the micro factory. This is done by bottle identifier 142 which can identify a genuine bottle by optical code, such as barcode or QR code or by another beacon such as a RFID tag. This is to ensure for example that the volume remains constant when bottles 116 are filled and to ensure proper movement, sanitizing and filling.

Upon bottles 116 being positioned in drop area 140, the bottle will travel and be mechanically flipped over to then enter a washing and sanitizing area 144 where a jet solution will clean and rinse the inside thereof. Alternatively, other sanitizing means can also be used, such as UV disinfection, ozone solution or gas, peroxide solution, peroxide generation in situ, chlorine, heat, steam or other means.

The bottle will migrate to a drip-dry station 146, with optional forced air drying 148, before being flipped up again by flipper 150 and directed to labelling 152 with an adhesive label that can for example feature pictorial, brands, contents, etc. The bottles then mechanically proceed to filling. In an embodiment, a bottle is first filled with extracts or additives 124 before being filled with water, carbonated or not and seal capped. The filled bottle is then available for pick-up by the consumer.

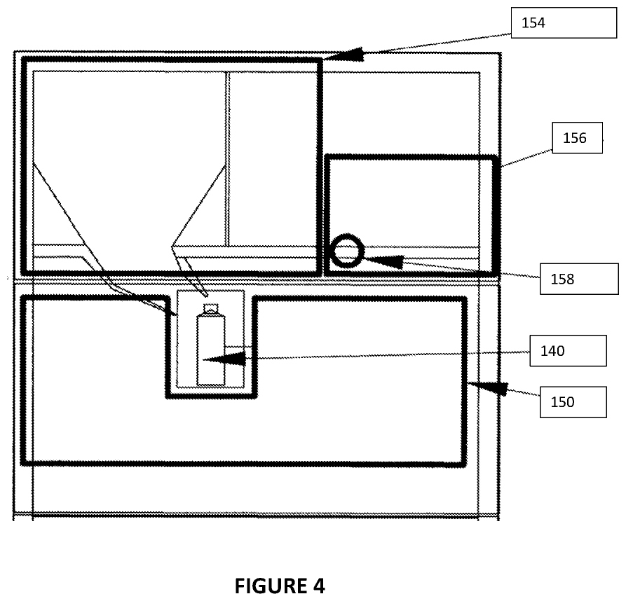

Referring to FIG. 4, there is shown a schematic view of the outside front of micro factory 100. A main screen 154 will display advertising, pictorials, user instructions or live events or even a live camera feed of an approaching consumer. A secondary screen 156 will feature a user interface a camera and microphone inputs 158. For sanitary reasons, secondary screen 156 may be provided with touchless controls as opposed to a haptic touchpad or keyboard inputs. Camera and microphone 158 can be used to recognize the user via facial recognition or can be used to record video and messages left by the user. More explanation on these features will be described in the next section. Finally, lower surface 160 will preferably be made of thick solid glass, preferably fully transparent or etched and capable of displaying various color schemes or effects and capable of displaying the inner working of micro factory 100 during a bottle cleaning and filling cycle.

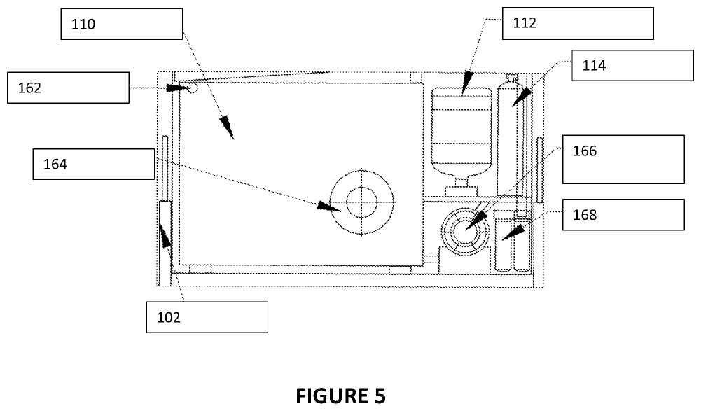

Turning now to FIG. 5, there is shown a schematic view of the interior of the lower portion 108 of micro factory 100. This portion is where the heavier items such as water reservoir 110 and external reservoir 112 are housed. A water inlet port 162 is provided in water reservoir 110. Thus, water reservoir 110 may be fluidly connected to a municipal water source or well (not shown). This is of course preferable to transporting water containers. An important feature of the micro factory of the present technology is to provide various custom made flavored drinks while avoiding transportation of water over large distances. A water sanitizing UVB lamp 164 is provided for irradiating the water in reservoir 110. Other known sanitizing means such as water filters can be used. A cooling compressor and pump 166 is provided as well as a single stage or multistage filtration device 168. Thus, water is reservoir 110 can be cooled in advance of use. The micro factory 100 further comprises means for purging and sanitizing the circuits and tubes of water, flavoring agents, extracts, etc.

The micro factory 100 will of course contain various electronic processors, including a central processing unit for controlling production cycles, beverage creations, cleaning and rinsing cycles, user interface communications, camera and microphone and self-diagnosis of functionalities. The micro factory 100 will contain internal sensors (not shown) to monitor the supply levels of spare bottles 116, and of flavors, additives and extracts. These could be light sensors, weight sensors, and the like.

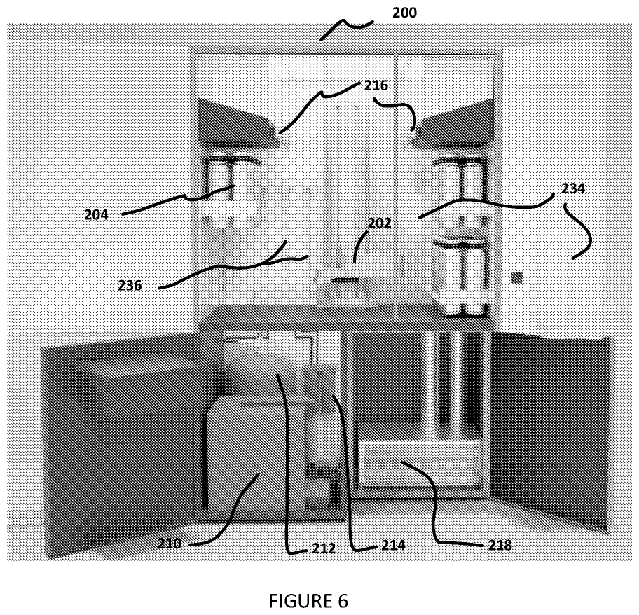

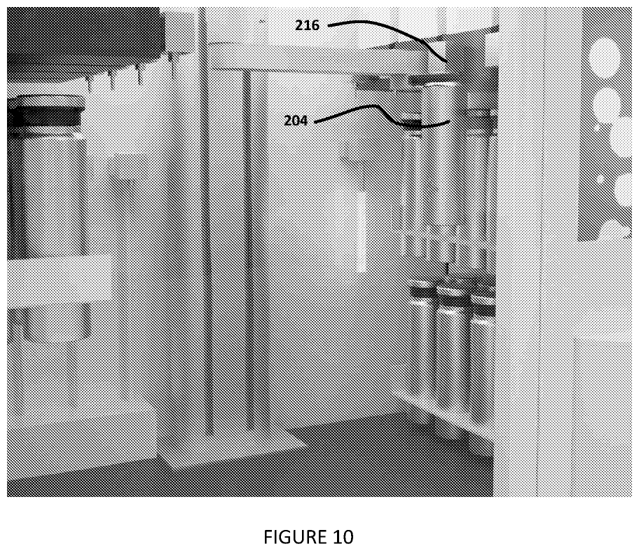

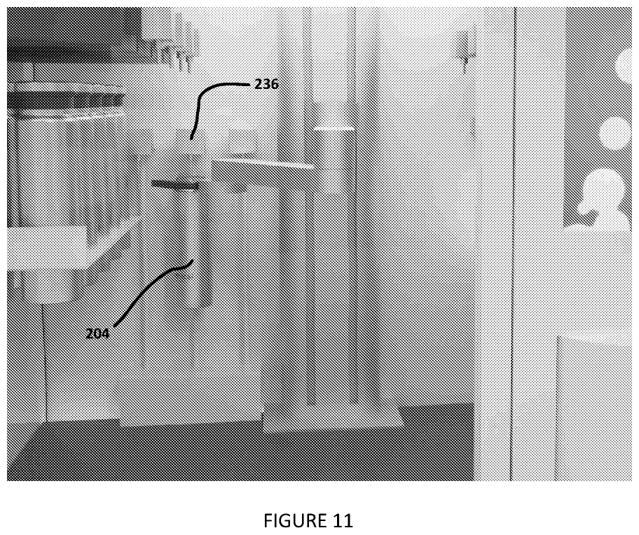

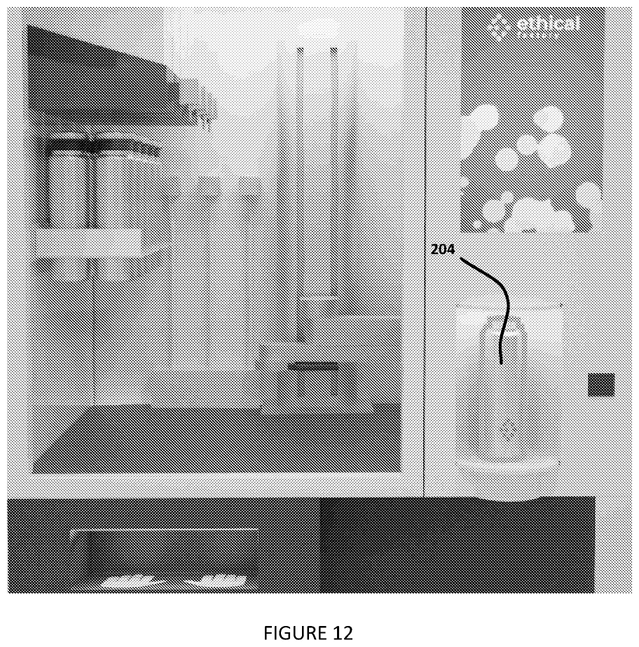

Another embodiment is illustrated in FIGS. 6 to 16. In FIG. 6, there is shown a microfactory 200 having a three-axis robotized arm 202 capable of seizing reusable bottles 204 and positioning these for a sanitizing inside at a bottle sanitizing station 206 and outside at a bottle drop-off zone 208. The robotized arm 202 is linked by an interface to a processor commanding the robotized arm and various other components in the micro factory in the required beverage preparation sequence and accordance to instruction inputs from a user/consumer.

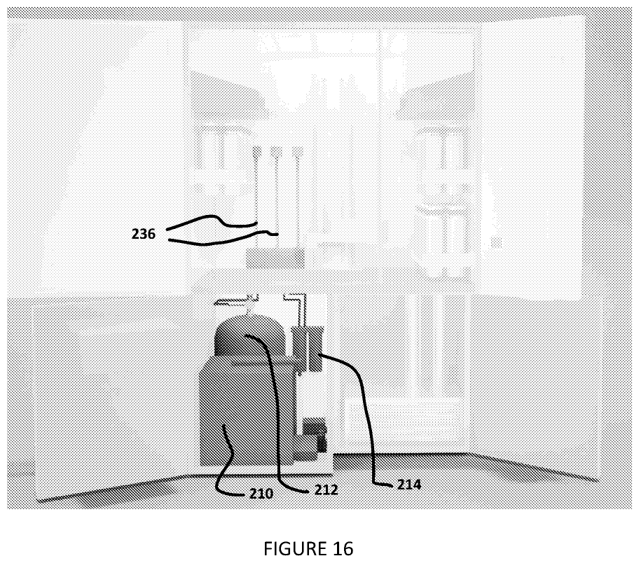

Shown with protective doors open and also referring to FIG. 16, the micro factory, in a general sense comprises a tap water cooling unit 210, a carbonation gas unit 212 and a water filtration unit 214. Tap water enter through the water filtration unit 214, is then cooled by the tap water cooling unit 210. Spare reusable bottles 204 are housed in the micro factory 200 and ready to be grasped by the robotized arm 202 when a user/consumer wishes to purchase a bottle.

Micro factory 200 also comprises concentrate and flavoring extract containers provided with dosing and metering heads 216. Micro factory 200 also comprises a HEPA air filtration unit 218 with positive pressure so as to purify the air inside the micro factory 200 and avoid dust or other contaminants.

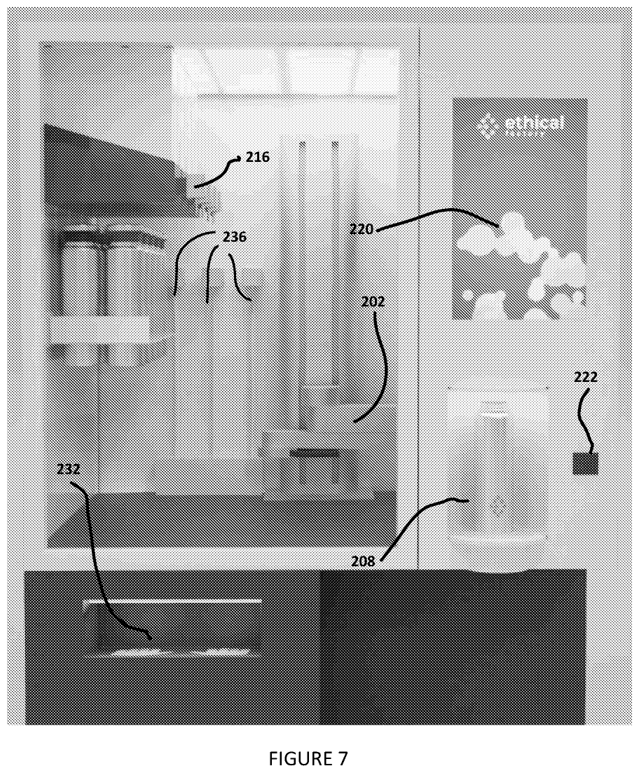

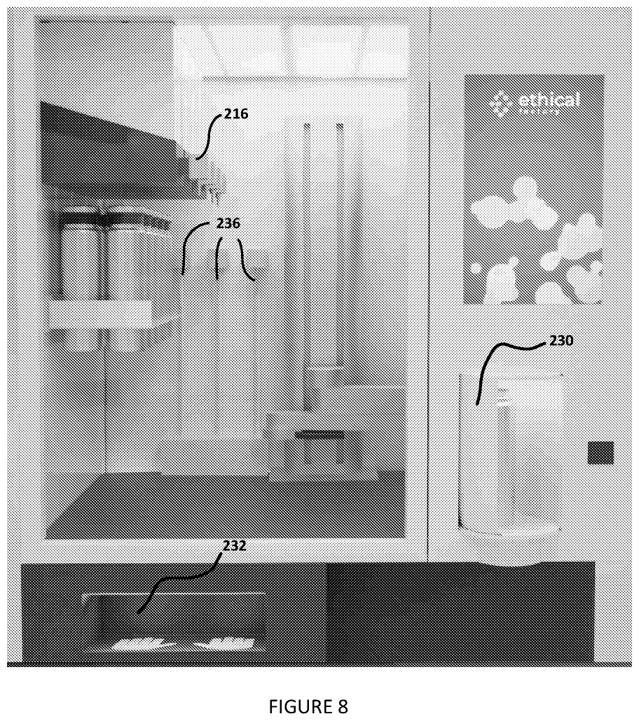

Referring to FIG. 7, the micro factory is shown with its protective doors in a closed and locked position. Advantageously, micro factory 200 has windows allowing user/consumer to visualize the movements and preparations within the micro factory 200. Also, outside walls of the micro factory can be coated with coatings to minimize germ proliferation such as powder coated titanium dioxide or Microban™ coatings.

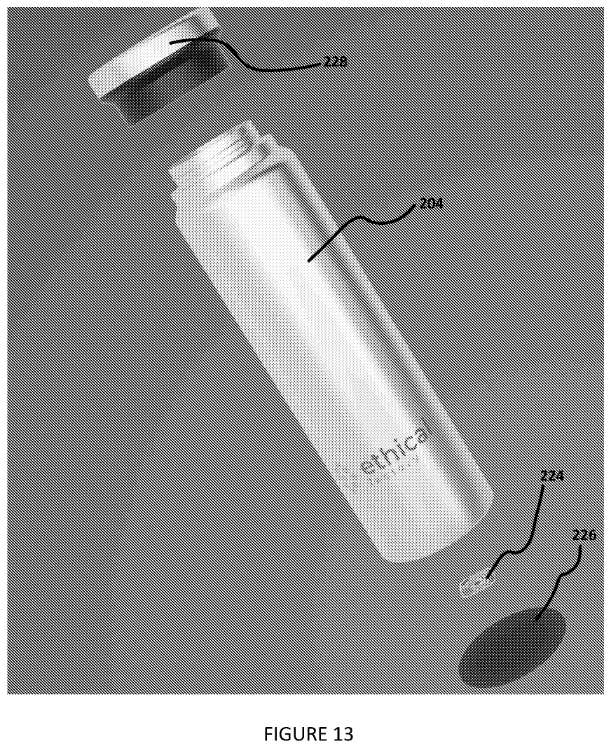

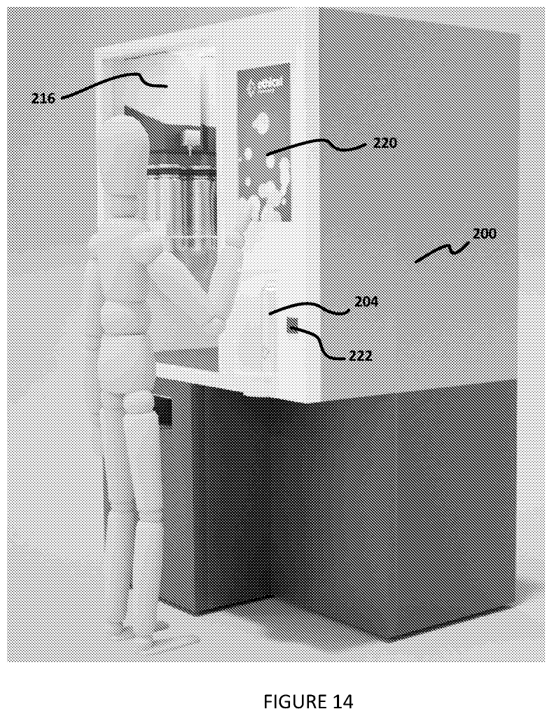

Input screen 220 and payment device 222 allow user/consumer to select the creation of the beverage of their choice and effect payment from an interface of selectable options. When the user/consumer arrives with their reusable bottle 204, the bottle 204 is recognized by its RFID tag 224 placed under a non-slip cushion 226 as shown in FIG. 13. Bottles 204 are conveniently provided with a screw cap 228.

Referring to FIGS. 7, 8 and 12, when a user/consumer uses the micro factory 200, they first remove screw cap 226 and place bottle 204 on the bottle drop zone 208. They also place the screw cap 226 and place their hands in UV light sanitizing station 232. By selecting and programming through input screen 220, a sequence is initiated whereby cover 230 is closed as illustrated in FIG. 8.

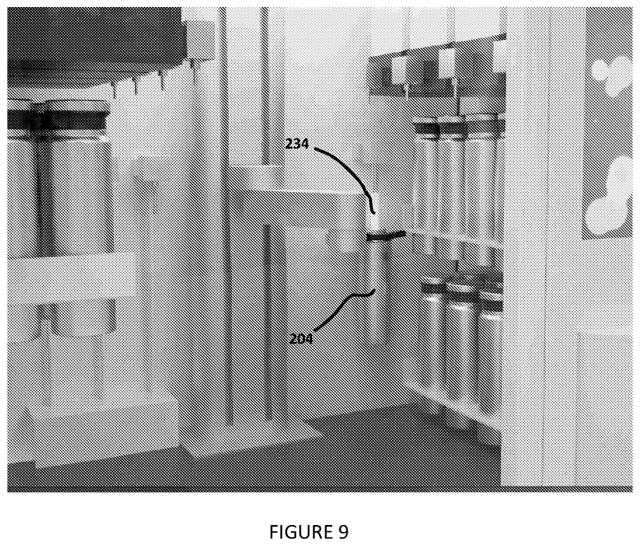

As shown in FIG. 9, the empty bottle 204 is sanitized by UV light source 234 before it is filled and can be sanitized again, as shown in FIG. 12, when it is returned to the user/consumer in bottle drop off zone 208.

The operation of the micro factory will now be further described in relation to FIGS. 9 to 12. As described earlier, the RFID tags 224 allow micro factory 200 to recognize the reusable bottle 204 and link it to an ownership profile to a client database. At that point, micro factory can greet the consumer by name via a speaker system (not shown) and may suggest the repeat purchase of beverages previously made by the micro factory 200. Once in micro factory 200, the robotized arm 202 will grasp and move bottle 204 to be filled with one or more extracts, concentrates or flavoring agents from metering heads 216 that are commanded by a microprocessor (not shown). Bottle 204 is then displaced by robotized arm 202 to a water filing station 236 where it is filled with choices of carbonation and temperature via distinct metering heads. Once the filling is completed, bottle 204 are returned to bottle drop off zone 208, sanitized by UV light and cover 230 is opened so that the user/consumer can take the bottle 204 and replace its screw on cap.

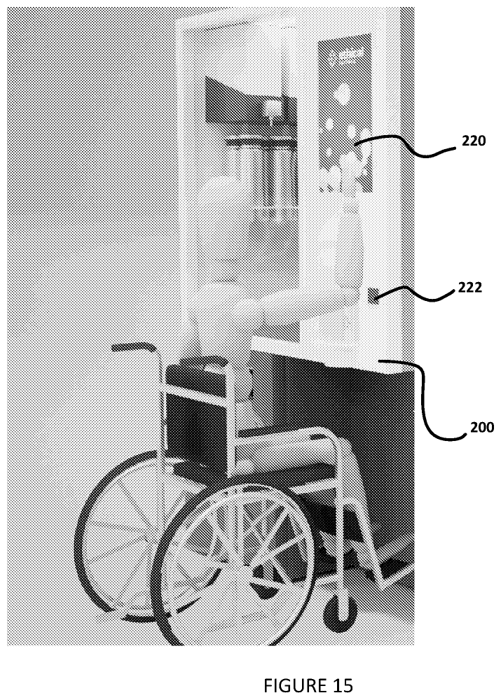

As shown in FIGS. 14 and 15 the micro-factory is advantageously sized and shaped to provide inclusive access for customers of various heights or those who may be confined to a wheelchair.

### Other Micro Factory Features and Functionalities

In practice, consumers will be greeted by the micro factory robotics upon arrival within camera range and proximity to the unit. If the consumer has previously consented to facial recognition and greeting via a smartphone application, for example, the micro factory will greet the user by first name and engage conversation such as suggesting a repeat of the last drink prepared. The micro factory will operate either on voice recognition protocol or by user interface inputs. Menus will be provided on the user interface to select bottle (bring in or purchased from stock) and to select the custom beverage to be created. The consumer has a myriad of choice of extracts, supplements, flavoring agents and carbonation level. As such, hundreds of custom combinations are possible. Alternatively, the user interface menus will provide preferred choices of beverages for quick selection. Also, the smartphone application can be used to place an advance order for a particular drink. The advance order would be prepared and kept ready in a retrieval zone.

Micro factory 100 will record consumer choices in a remotely accessed database (for those consumers who have consented) and will invite the consumer to record a video message for broadcasting on social media or for direct messaging to selected individuals or platforms. Micro factory 100 face and walls will also feature specific color patterns and displays in accordance with time of day, choice of beverage and so on. Furthermore, as a beverage is created, the inner workings of micro factory 100 can be displayed showing the beverage creation process.

Another feature and functionality of micro factory 100 is that it will be linked by communication means via a secure network to a remote central station for monitoring, controlling and diagnosing the supply levels, functions and service requirements of micro factories 100 deployed at various locations. Referring to FIG. 6, as such, service and supply crews will only be dispatched upon need and energy conserving service routes will be devised. The communication via a secure network will be a two way communication meaning that the remote central station will be able to communicate and implement instructions for the micro factory 100. These instructions can include for example, a change of display features such as light colours or other visual information displayed by the micro factory 100. The central station will also be able to communicate software updates and reset instructions or the like.

As a non-limiting example, artificial intelligence will also be used to predict supply and service requirements as well as consumer preferences depending on previous choices, time of day, weather and time of year. Thus, the processor(s) either in micro factory 100 or at a remote central station will feature Machine Learning Algorithims (MLAs) trained to recognize and predict such patterns and provide recommendations accordingly via a server and processors and communication means over a network.

As a non-limiting example, one or more MLAs of a set of MLAs may be hosted on a cloud service providing a machine learning API.

### Mobile Application

Furthermore, the user interface of micro factory 100 will also be provided on a dedicated smartphone application. The application can provide the geographic location of the nearest micro factory, social media interfaces, product information such as sugar content, caloric load or other ingredient content. The application can also provide product pricing information and information on environmental advantages of the micro factory 100 especially in comparison to the transportation and storage of millions of disposable plastic bottles and the transportation of water-based drinks over large distances such as by trucks. The application can also contain means to join a membership of consumers using the micro factory and means for providing rebates upon repeated purchases. The application can also feature consumer testimonials and chats. The application can also feature means to suggest new flavors and new drinks in relation to the wants and needs of the consumers such as energy, calming effect, low calorie, carbonated, sweet, etc. The application can also feature means to record a consumer profile.

### Database

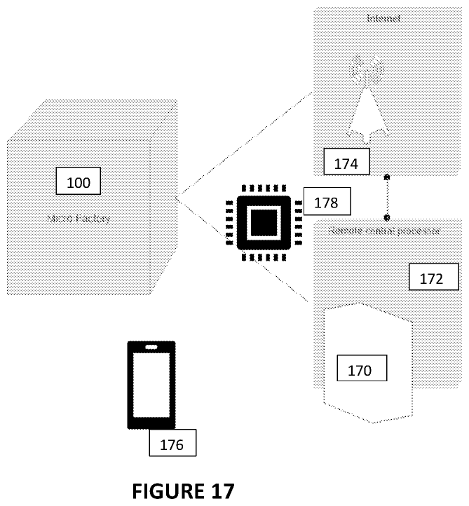

Referring to FIG. 17, a database 170 is communicatively coupled to the server 172 via the communications network 174 but, in one or more alternative implementations, the database 170 may be communicatively coupled to the server 172 without departing from the teachings of the present technology. Although the database 170 is illustrated schematically herein as a single entity, it will be appreciated that the database 170 may be configured in a distributed manner, for example, the database 170 may have different components, each component being configured for a particular kind of retrieval therefrom or storage therein.

In one or more embodiments of the present technology, the database 170 is configured to inter alia: (i) store information relative to the plurality of micro factories 100, including location; (ii) store data relative to users of the plurality of client devices 176 (iii) store data including images captured by the plurality of micro factories 100; and (iv) store parameters of the set of MLAs 178.

As a non-limiting example, the database 170 may store information such as frequency of beverage orders, numbers of orders, flavor mix combinations and various other statistics.

### E-Commerce Platform

In one or more embodiments, smartphone applications may also comprise an e-commerce platform to preorder beverages or to determine the location of micro factories 100 in a given urban environment or to provide social media functions such as message boards for communication between consumers and friends. The e-commerce platform can also be used to order flavoring agents, extracts or additives in pouches or other means so as to replicate drinks within a home setting.2022-05-30

Modifications and improvements to the above-described implementations of the present technology may become apparent to those skilled in the art. The foregoing description is intended to be exemplary rather than limiting.

1.-14. (canceled)

15. A micro factory system for on-demand dispensing of beverages in response to consumer preferences, said system comprising an internal enclosure, an external frame, a water supply, a carbon dioxide supply, a plurality of supply means for storing extracts, flavoring agents or additives, a reusable bottle supply, an air filtration system for providing filtered air into the internal enclosure, wherein the air filtration system is a HEPA grade forced air filter and wherein the air filtration system is configured to maintain a positive pressure in the internal enclosure, at least one sanitizing station for bottles submitted for beverage preparation by the micro factory system, a reusable bottle filling station, said system further comprising a consumer interface for programming by consumers so as to cause said micro factory to generate a custom beverage and further comprising network interface for networking said system to a remote location, wherein the reusable bottles are provided with a removable cap and wherein said consumers may sequentially present the reusable bottles to a bottle drop zone accessible from said external frame, wherein the system is configured to transport the reusable bottles from the bottle drop zone to the internal enclosure and to at least one of the sanitizing station, reusable bottle filling station and supply means for storing extracts, flavoring agents or additives, and wherein once filled in the internal enclosure the reusable bottles are sequentially returned to the bottle drop zone for retrieval by the consumers.

16. The micro factory in accordance with claim 15 further comprising a water supply filtration means.

17. The micro factory in accordance with claim 15 further comprising a hand sanitizing station comprising an ultraviolet light source accessible to consumers on the external frame of said micro factory.

18. The micro factory in accordance with claim 15 further comprising display means for displaying advertising or other visual contents and further comprising means for social media access for consumers.

19. The micro factory in accordance with claim 15 further comprising camera and microphone means.

20. The micro factory in accordance with claim 15 further comprising a robotized system for grasping and moving said reusable bottle within said bottle drop zone and internal enclosure.

21. The micro factory in accordance with claim 20 wherein the robotized system comprises a three-axis prehensile and movable arm.

22. The micro factory in accordance with claim 19 further comprising means for facial recognition of consumers and consumer interaction upon approach within visual range of said camera.

23. The micro factory in accordance with claim 15 further comprising means for identifying reusable bottles that are compatible for use in said micro factory.

24. A reusable bottle configured to be used in the micro factory in accordance with claim 15 wherein said reusable bottle is provided with an RFID tag or beacon for recognition by said micro factory.

25. A method of operating a micro factory in accordance with claim 15 wherein said micro factory is communicatively linked to a network said method comprising measuring levels of supplies and communicating with said network to inform a database and processor of supply levels so as to generate network alerts upon low supply levels.

26. The method of operating a micro factory in accordance with claim 25 wherein said network alerts are issued by said micro factory over said network in response to detected or predicted supply levels and service requirements and thereby generates a service call responsive to said conditions.

27. The micro factory in accordance with claim 15, wherein the additives are nutritional additives.
